(19) United States
(12) Patent Application Publication
(10) Pub. No.: US 2013/0290040 A1
(43) Pub. Date: Oct. 31, 2013

(54) Method and System for Arranging Taxi and Transportation Services

(71) Applicants: Alexander Perry, Alamo, CA (US); Trent Mervine, Dallas, TX (US); Ryan Arndt, Houston, TX (US)

(72) Inventors: Alexander Perry, Alamo, CA (US); Trent Mervine, Dallas, TX (US); Ryan Arndt, Houston, TX (US)

(21) Appl. No.: 13/455,928

(22) Filed: Apr. 25, 2012

(51) Int. Cl. G06Q 10/02

(52) U.S. Cl. 705/5

(57) ABSTRACT

The invention relates to a method and system to directly link and arrange taxi and transportation services. The method and system allows a user to link directly into the associated taxi dispatch system and order a cab, as well as finding friends and other users through social media applications to interact with, share rides and split payments. A user can join a cab ride already in progress by linking to the other riders that have already booked a cab ride.

### FIELD OF THE INVENTION

This invention relates generally to a link to an application programming interface associated with taxi or transportation service directly from an individual through telephone, personal computer or social media.

### BACKGROUND OF THE INVENTION

Taxi and transportation systems each have a unique application programming interface that permits the company's central dispatch to schedule and arrange taxi and transportation services to pick up and/or drop off customers.

The central dispatch is initially contacted through a telephone call or computer from a customer. Subsequent to the telephone or computer order, the dispatch department will locate a nearby vehicle to pick up the customer. The uncertainty and loss of time associated with the order with the central dispatch and the driver can cause undue frustration with the customer.

It is desirable to remove the indirect link of contacting a central dispatch before a customer places his transportation order. However because an old system of taxi companies and transportation services utilizing a central dispatch has been around for years, such change is not easily made.

### BRIEF DESCRIPTION OF THE DRAWINGS

In order to more fully understand the manner in which the above-recited and other advantages and objects of the invention are obtained, a more particular description of the invention will be rendered by reference to specific embodiments thereof which are illustrated in the appended drawings. Understanding that these drawings depict only typical embodiments of the invention and are therefore not to be considered limiting of its scope, the invention in its presently understood best mode for making and using the same will be described with additional specificity and detail through the use of the accompanying drawings in which:

FIG. 1 shows a sequence of steps for a customer to initially book a cab through a personal computing device found on a commonly used smart-phone.

FIG. 2 shows a sequence of steps for a customer to locate friends through a social media application who may need similar transportation services.

FIG. 3 shows a sequence of steps for a customer who has joined with friends to split the payment of the fare.

### DETAILED DESCRIPTION OF THE DRAWINGS

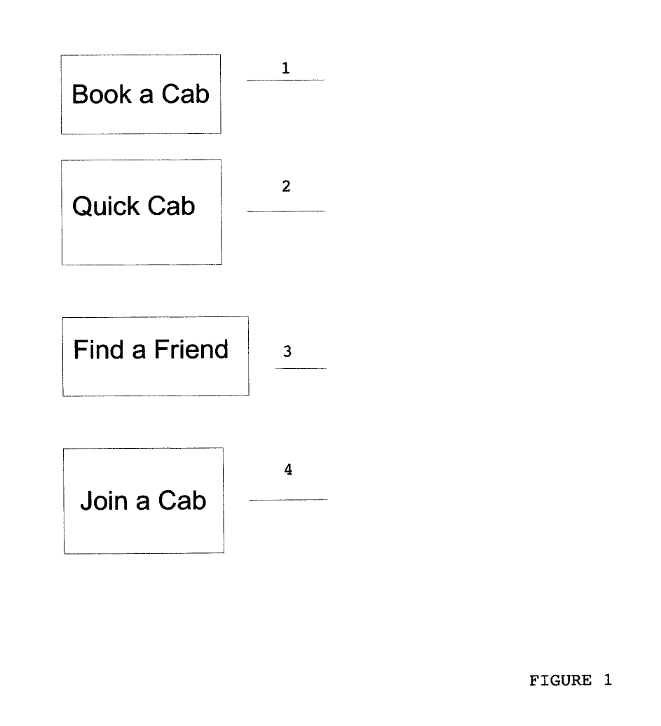

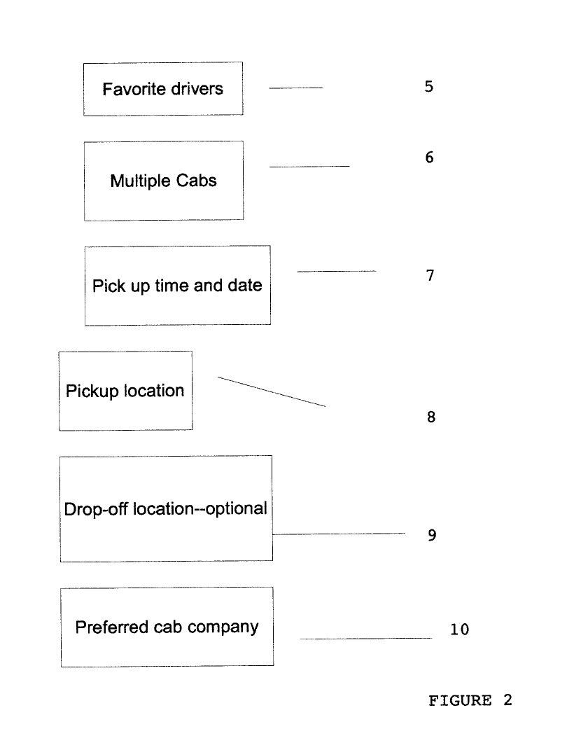

FIG. 1 depicts a design screen to show how an individual may book a cab (1) through a direct link into the associated taxi or transportation service dispatch system and order service through the companies application programming interface. This book a cab screen (1) provides the user with many different locating tools, scheduling possibilities and options.

A quick cab (2) screen utilizes a location feature found on many common smart-phones or other personal computing devices which sends a cab as soon as possible to the user's current location as determined by the smart-phone or personal computing device. All of the information is processed through the application programming interface and sent over the services' dispatch system. This quick cab (2) feature includes all of the features contained in the book a cab (1) feature, but automatically includes location information.

The find a friend (3) screen links the application to others users' social media accounts. This allows the user to interact with other people on the application in several ways including an ability to find potential riders and to split payments with them.

By selecting the join a cab (4) feature and entering in the cab's unique identification, the user will be able to link with other riders that have already booked or joined the cab (4) in order to spilt payments. Optionally, by joining a cab (4) a user can catch a ride off the street without booking and still have the ability to pay on his smart-phone or personal computing device with a credit card.

FIG. 2 displays the details of the features included within book a cab (1). The book a cab (1) feature prompts the user initially for a possible favorite driver (5). This option (5) allows a user to save favorite driver (5) information to contact them for future rides. By saving a favorite drivers' (5) individual identification, the application will be able to access the taxi provider's dispatch system in order to book the favorite driver (5). Favorite drivers (5) may be kept under a recent or bookmark tab on their favorite driver (5) page for future contact and availability.

An additional tab for selection within the book a cab (1) feature would be the ability to select multiple cabs (6) if the user needs more than one cab due to the size of their group.

Once the customer has selected his favorite driver(s) (5) within book a cab (1) and determined whether there is a need for multiple cabs (6), the customer schedules his pick-up date and time (7). This option permits the customer to select a pick-up time and date (7) that can be scheduled for a day and/or time in the future. This process will need to save the scheduled pick-up date and time (7) and send the order automatically to the taxi dispatch system through the server that handles the applications, communications and processes.

The cab is then provided with the customer's current location (8) preferably automatically calculated using the customer's built-in GPS capabilities on their smart-phone or computer device or alternatively entered in manually.

The cab is then optionally provided with drop-off location (9) information with the same mechanics of the customer's current location (8).

The present invention additionally allows the rider to select their preferred cab company (10), in a similar way that the favorite driver (5) is selected.

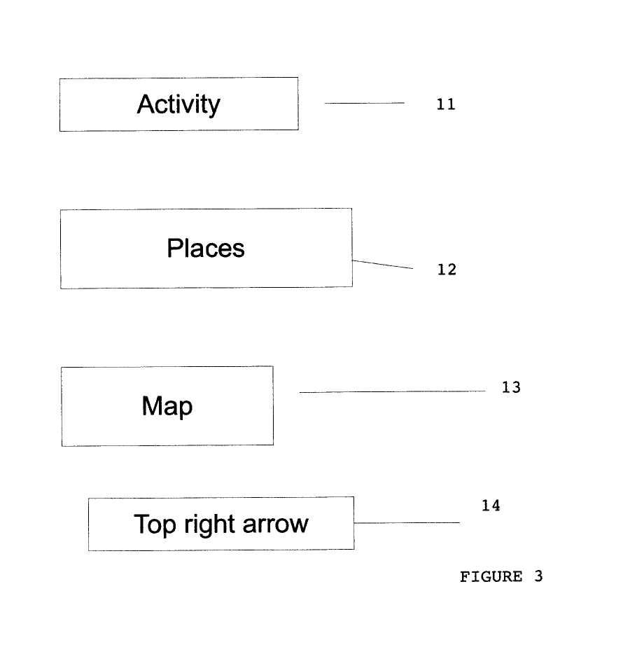

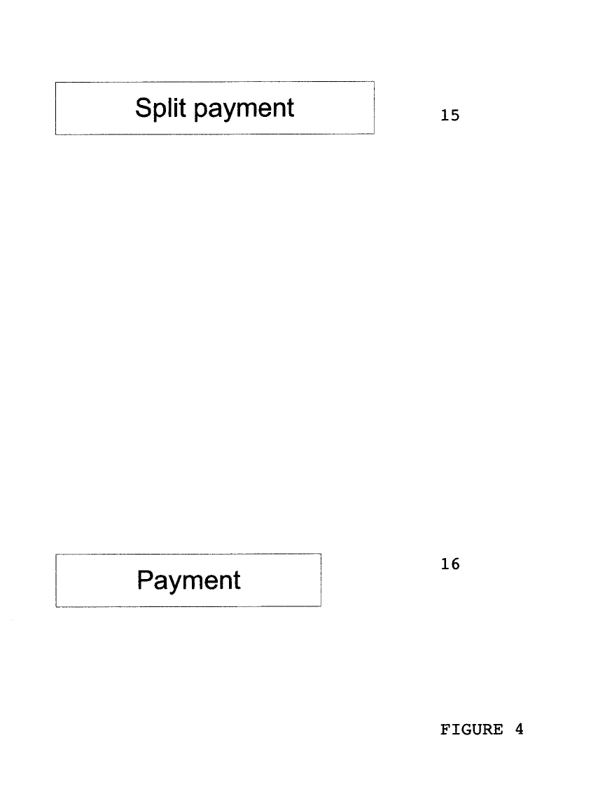

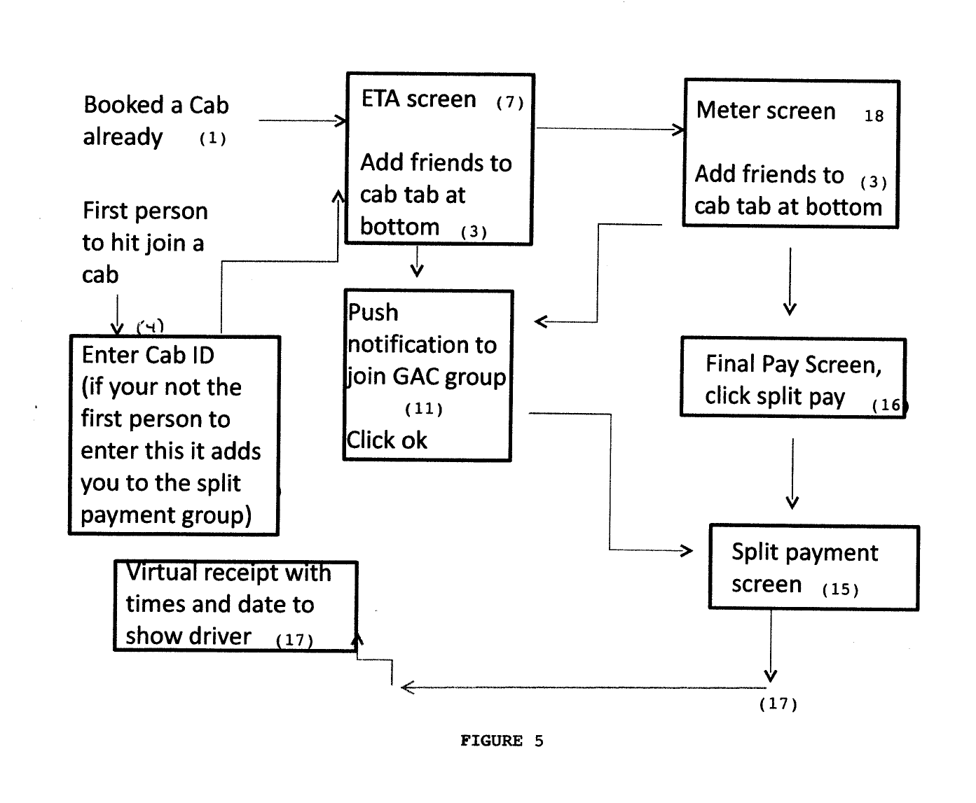

Referring now to FIG. 3, the customer can utilize find a friend (3) through a selection process utilizing a social media application.

When the user selects to find a friend (3) they will be brought to a screen with options. The application will automatically filter to only display friends that have the application and are in the same city.

An activity option (11) displays for the user all the recent locations with which friends have checked in at. This activity (11) information can be organized preferably by listing the most recent at the top. Places can be integrated through social media applications and can be added by other friends or the user on the screen to add a place (12).

The screen to add a place (12) permits the user to search specific places in order to locate friends.

A map screen (13) drops a pin on a map at the approximate spot where each friend recently checked in to. The user may click the pin on the map screen (13) in order to see more information. Once the user checks into the same location, the user will be identified by a pin clarified by a number or color on the pin on the map screen (13) signifying the number of users checked in at that same location.

An identifier or right top arrow (14) on the screen allows the user to check in as described in places and search for specific friends similar to those features used on common social media application. Clicking on a friend will display their last known location and who they were grouped with.

FIG. 4 displays an option between a split payment (15) and a payment (16). The split payment (15) allows a user to divide up the fare among other riders in the cab that also have the application. The first user to book or join the group is given control over the group. This initial rider can add friends under estimated time for arrival, meter and split payment screen (15) options by selecting friends through a social media application. By selecting the split payment (15) the user goes to a search screen to search for a friend. Upon selecting the desired friend a notification is sent to that user prompting them to join the cab group. Users may also join the group by entering the cab identification. All riders that have been added are placed in the split payment (15) screen where they can watch the meter run and payment amounts. Upon arrival and when the meter has been stopped, the first user to book or initiate the group will determine how the group will pay. When the initial user selects pay now a push notification will be sent to each member of the group asking if the amount assigned is ok to be charged to the credit card information embedded within the application. After all the members of the group have approved payment, the payments will go through and a virtual receipt (17) will be displayed on each riders' split payment (15) screen.

If the user is alone and has no-one to split the fare with, they will simply be prompted for payment (16). In order to make a payment (16) a user must embed a credit card within the application. This information will be stored on a secure merchant account system. By selecting payment (16) to pay now, the user will be prompted to approve the charge. Upon approval, the payment (16) will be processed and a virtual receipt (17) with detailed information surrounding the transaction displayed.

FIG. 5, displays a detailed flow chart of the final technicalities of the click-through process. Here the user is prompted to book a cab (1) if he is the first user and then optionally find friends (7) to ride along with. This information is sent to a meter screen (18) which links to the taxi cab dispatch provider's application programming interface to show the cab's meter in real time on the user's smart-phone or personal computing device. Alternatively, the user can join a cab (4) if they are not the first person in the cab. From booking the cab (1), the user can find friends (3) to ride along with who can accept and join the cab (11), determine payment (16), whether to split the payment (15) and finally obtain a virtual receipt (17) once the ride is terminated.

What is claimed is:

1. A system and method for arranging taxi and transportation services comprising:
a smart-phone or personal computing device,
said device capable of making direct wireless communication with a transportation service application programming interface,
said device providing the ability to arrange transportation services through a plurality of selections for transportation for driver selection, multiple vehicles, pick-up time, pick-up date, pick-up location, drop-off location, drop-off time and preferred transportation company.

2. The system and method in accordance with claim 1, wherein the device communicates its location directly to the transportation service through a global positioning or other location application within said device.

3. The system and method in accordance with claim 1, wherein the user is linked directly to other users through a social media application,
said social media application links directly to other users displays for activity and recent locations and with which friends have checked in,
said direct link searches specific places in order to locate other social media users and friends,
said application contains a map and provides location information each friend recently checked in to,
said application contains an identifier, preferably in the form of a top right arrow which allows the user to check in as described in places and search for specific friends similar to those features used on common social media application.

4. The system and method in accordance with claim 1, wherein the application provides an option to split payments among the users,
said split payment allows a user to divide up the fare among other riders in the cab that also have the application,
said split payment can be determined by a plurality of factors which may include estimated time of arrival and fare meter reading,
once said payment is determined notification will be sent for confirmation,
after said payment has been approved, it will go through a pre-selected process and a receipt will be provided,

5. The system and method in accordance with claim 1, wherein if the user is alone and has no-one to split the fare with, the user will simply be prompted for payment, and upon approval, the payment will be processed and a receipt will be issued.
